(19) United States
(12) Patent Application Publication
(10) Pub. No.: US 2006/0106147 A1
(43) Pub. Date: May 18, 2006

(54) Method for making nanocomposite materials

(76) Inventors: Paula D. Fasulo, Eastpointe, MI (US); William R. Rodgers, Bloomfield Township, MI (US); Robert Augustine Ottaviani, Anthem, AZ (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 10/987,168

(22) Filed: Nov. 12, 2004

(51) Int. Cl. C08K 9/04

(52) U.S. Cl. 524/445

(57) ABSTRACT

A method for making a nanocomposite material includes introducing a polymeric material and a nanofiller material into a conical twin-screw extruder. The extruder is adapted to impart substantially gentle shearing of the polymeric material and the nanofiller material, thereby forming the nanocomposite material. The nanofiller material is dispersible within the polymeric material substantially without the use of an external compatibilizing material. The use of the conical twin-screw extruder substantially eliminates the need to use an external compatibilizer to produce a nanocomposite material having enhanced properties (e.g. physical properties, mechanical properties, etc.).

### TECHNICAL FIELD

Embodiments of the present disclosure relate generally to nanocomposites, and more particularly to the formation of nanocomposite materials.

### BACKGROUND

Nanotechnology can be defined as materials or devices engineered at the molecular level. Within this category are polymer nanocomposites, which are a class of materials that use molecular sized particles for reinforcing the polymer matrix, e.g. the reinforcing filler possesses one or more dimensions on a sub-micrometer scale. These materials blend an organoclay with a polymer to produce a composite with equal or better physical and mechanical properties than their conventionally filled counterparts, but at lower filler loadings.

Due to the surface area available with nanofillers, polymer nanocomposites offer the potential for enhanced physical properties, mechanical properties, barrier properties, thermal properties, and flame retardant properties when compared to conventionally filled materials.

Conventional twin-screw extruders may be used to make nanocomposite materials. However, in some instances, the inorganic phase is not compatible with the organic matrix (polar versus non-polar conflicts), resulting in a lower flexural modulus of the final nanocomposite material. An external compatibilizer may be added during fabrication of the nanocomposite in order to ameliorate the non-compatibility of the phases and to increase the flexural modulus of the nanocomposite. In some instances, the external compatibilizer may add additional steps and expense to the fabrication of nanocomposite materials.

Thus, it would be desirable to provide a method of forming nanocomposite materials without an external compatibilizer, which nanocomposite materials exhibit enhanced properties, for example, enhanced physical properties.

### SUMMARY

Embodiments of the present method disclose a method for making a nanocomposite material(s). The method includes introducing a polymeric material into a conical twin-screw extruder, and introducing a nanofiller material into the polymeric material within the conical twin-screw extruder. The extruder imparts substantially gentle shearing of the polymeric material and the nanofiller material, thereby forming the nanocomposite material. The nanofiller material is dispersible within the polymeric material without an external compatibilizing material, and the resulting nanocomposite material exhibits enhanced properties (e.g. physical, mechanical, etc.).

### BRIEF DESCRIPTION OF THE DRAWINGS

Objects, features, and advantages of embodiments of the present disclosure may become apparent upon reference to the following detailed description and drawings, in which:

FIG. 1 is a cutaway front view showing an embodiment of a conical twin-screw extruder useful in embodiments of the method of forming a nanocomposite material; and

FIG. 2 is a transmission electron microscopy (TEM) image of an embodiment of a nanocomposite material.

### DESCRIPTION OF THE EMBODIMENTS

Thermoplastic materials are generally used for vehicle cladding and fascia systems, and may soon become the preferred materials for substantially all body panels and interior systems. Nanocomposite materials are a relatively new class of thermoplastic materials that use molecular-sized particles for reinforcing the polymer matrix. These materials generally blend an organoclay nanofiller with polyolefins to produce a composite with substantially improved physical and mechanical properties.

It has been discovered that, for optimal reinforcement properties in nanocomposite materials, good exfoliation of the incorporated nanofiller material is desirable. Further, good dispersion of the layers of the nanofiller (e.g. silicate layers) throughout the resin, and compatibility between the polymer resin(s) and the filler(s) are also desirable.

Methods for preparing polyolefin nanocomposites generally incorporate the use of an external compatibilizer. This compatibilizer may, in some instances, have a significant impact on properties such as flexural modulus and coefficient of linear thermal expansion, but may also be a relatively expensive addition to the nanocomposites.

Without being bound to any theory, it is believed that the use of a conical twin-screw extruder for processing a nanocomposite material may result in the desired properties of the nanocomposite material without the use of an external compatibilizer.

Generally, embodiment(s) of the method include introducing a polymeric material and a nanofiller material into a conical twin-screw extruder adapted to impart substantially gentle shearing of the polymeric material and the nanofiller material, thereby forming a nanocomposite material. The use of the conical-twin screw extruder advantageously forms the nanocomposite material without an external compatibilizer therein, while having the desired properties of a nanocomposite material that does have an external compatibilizer therein.

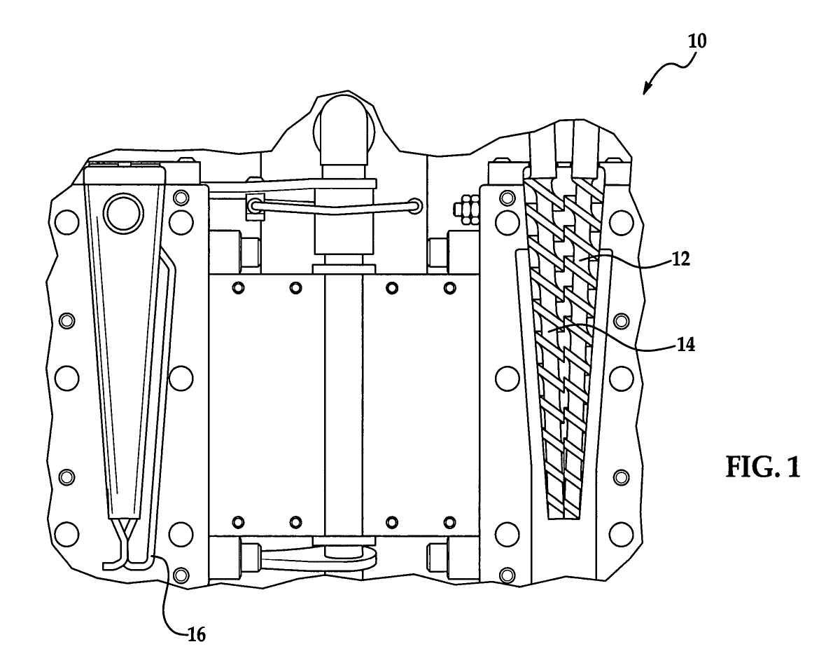

Referring now to FIG. 1, a non-limitative embodiment of a conical twin-screw extruder 10 is depicted. Polymeric material and nanofiller material are introduced into the extruder 10. It is to be understood that the polymeric material and the nanofiller material may be added to the extruder 10 either substantially simultaneously or substantially sequentially. In a non-limitative example, the polymeric and nanofiller materials may be added to the extruder 10 via a hopper/plunger arrangement (not shown). It is to be understood that the time for introducing the materials into the extruder 10 may be any suitable amount of time depending, in part, upon the materials used, the amount of materials used, and the operating parameters (e.g. temperature) of the extruder 10. In an embodiment, the time for introducing the polymeric and nanofiller materials into the extruder 10 ranges between about 1 minute and about 6 minutes. It is to be understood that the feed rates of the materials into the extruder 10 may depend, in part, on the size of the extruder 10. In an embodiment, the feed rates may be as low as about 25 lbs/hour (for a small conical extruder 10) and up to about 2,000 lbs/hour (for a larger conical extruder 10), or higher.

It is to be understood that the conical twin-screw extruder 10 used in embodiment(s) of the present method may be a co-rotating twin-screw extruder (a non-limitative example of which is shown in FIG. 1).

In an embodiment of the method employing a co-rotating extruder 10, the extruder 10 has two screws 12, 14 having screw flights that intermesh to generate a substantially constant action such that the polymeric material and the nanofiller material are substantially constantly moved from one screw 12, 14 to the other screw 14, 12. This action may result in a geometrically substantially regular path for the material(s) as they pass through the extruder 10. This action may also advantageously result in substantially distributive and gentle shear mixing of the materials. Without being bound to any theory, it is believed that the mixing and shearing motions of the conical twin-screw extruder 10 substantially allow the polymeric material and nanofiller material to form a nanocomposite having the desired properties, without the addition of an external compatibilizer.

In an embodiment, the extruder 10 is fitted with a re-circulating channel 16. This channel 16 may allow the polymeric material and nanofiller material to travel, for example, from the bottom region of the extruder 10 up to the top region of the extruder 10, where the materials may undergo additional cycles of mixing between the flights of screws 12, 14. Without being bound to any theory, it is believed that this configuration of the extruder 10 may be adapted to impart substantially elongational shear upon the polymeric and nanofiller materials. It is also to be understood that the shear rate values for the extruder 10 range between about 70 s⁻¹ and about 185 s⁻¹. Conical twin screw extruders typically may have shear rates ranging between about 70 s⁻¹ and about 500 s⁻¹ in comparison to conventional extruders which may have shear rate values that range between about 750 s⁻¹ and about 3,740 s⁻¹.

It is further believed that the passing of the polymeric and nanofiller materials through the extruder 10 via the screws 12, 14 and the re-circulating channel 16 for a predetermined amount of time, may contribute to the formation of the nanocomposite material having the desired properties without the addition of an external compatibilizer. The predetermined amount of time for processing the materials in the extruder 10 may depend upon, at least in part, the materials used, the force applied by the screws 12, 14, the mixing speed of the screws 12, 14, the temperature of the extruder 10, and/or the like. Further, the predetermined amount of time for processing may also be dependent upon whether any of the parameters (e.g. screw speed, temperature, force, etc.) are accelerated or decelerated during the mixing of the materials. In a non-limitative example, the predetermined amount of time for mixing (processing) may range between about 2 minutes and about 15 minutes. In a further non-limitative example, the predetermined amount of time for mixing (processing) is about 2 minutes.

The temperature of the extruder 10 may vary depending, in part, on the polymeric material(s) and nanofiller material(s) used. The temperature may also be elevated or lowered during the process as desired. In an embodiment in which the polymeric material is a thermoplastic olefin, the temperature of the extruder 10 during mixing may range between about 170° C. and about 300° C. Without being bound to any theory, it is believed that lower temperatures (e.g. about 175° C. to about 200° C.) may be advantageous for the preparation of nanocomposites in the conical twin-screw extruder 10.

The screw 12, 14 rotation speed may also be varied as desired. In an embodiment, the rotation speed ranges between about 25 rpm and about 250 rpm. The screw 12, 14 rotation speed may be substantially the same, similar, or different while introducing the polymeric and nanofiller materials into the extruder 10, emptying the nanocomposite material from the extruder, and/or mixing the polymeric and nanofiller materials together. It is to be understood, however, that generally a slower speed may be desirable during the introducing and emptying steps, whereas a faster speed may be desirable during mixing. A non-limitative example of a slower speed suitable for introducing and emptying is about 50 rpm, and a non-limitative example of faster speeds suitable for mixing ranges between about 175 rpm and about 200 rpm.

Still further, it is to be understood that the polymeric material may include any suitable thermoplastic materials. Non-limitative examples of suitable thermoplastic materials are thermoplastic olefins including at least one of polypropylenes, polypropylene homopolymers, impact modified polypropylenes, ethylene-propylene elastomers, polyethylenes, elastomers, impact copolymers thereof, and/or mixtures thereof. Further suitable examples of thermoplastic materials include, but are not limited to at least one of polypropylenes, polyethylenes, elastomers, polyolefins, impact copolymers thereof, polyamides, polystyrene, polyethyleneterephthalate, polymethylmethacrylate, polycarbonate, polyurethane, poly(acrylonitrile-co-butadiene-co-styrene) (ABS), poly(acrylonitrile-co-styrene-co-acrylate) (ASA), poly(styrene-co-butadiene-co-styrene) (SBS), polycarbonate-poly(acrylonitrile-co-butadiene-co-styrene) (PC-ABS), and/or mixtures thereof.

The nanofiller material may be any suitable nanofiller material. In an embodiment, the nanofiller is a clay material. Examples of suitable clay materials include, but are not limited to at least one of smectite, hectorite, montmorillonite, bentonite, beidelite, saponite, stevensite, sauconite, nontronite, illite, and mixtures thereof. In one non-limitative embodiment, the nanofiller is an aluminum silicate smectite clay. Alternately, the nanofiller may include an organically modified clay material, such as, for example, montmorillonite.

In an embodiment of the method, additives may optionally be added to the nanocomposite material. Non-limitative examples of suitable optional additives include antioxidants and/or light stabilizers.

The method may further include passing the formed nanocomposite material through the extruder 10 in order to exit the extruder 10. The nanocomposite material may then be subjected to injection molding and/or the like, as desired.

To further illustrate embodiment(s) of the present disclosure, the following examples are given. It is to be understood that these examples are provided for illustrative purposes and are not to be construed as limiting the scope of the disclosed embodiment(s).

### EXAMPLES

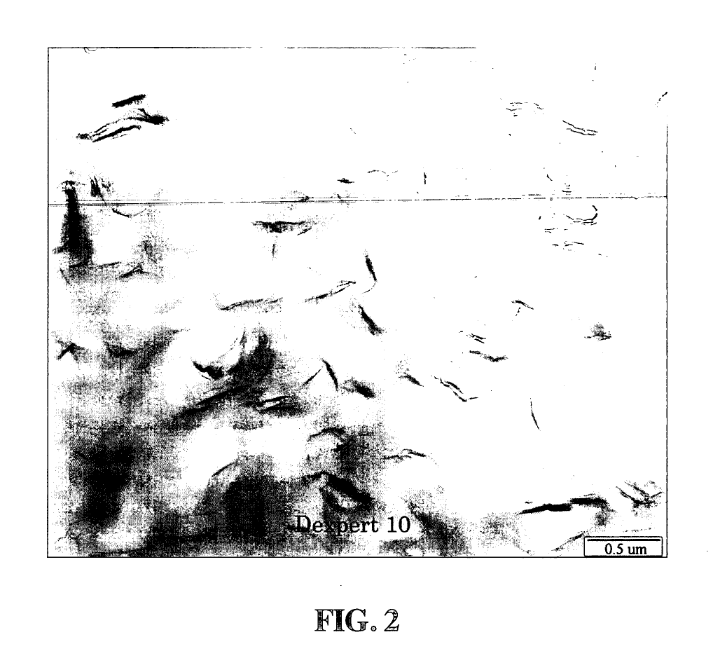

A tabletop microextruder system is used. The microextruder system has conical, co-rotating twin screws for compounding and mixing. Various amounts of different polymeric materials and nanofiller materials are added to and mixed within the microextruder (See Table 2). The microextruder mixes the polymeric and nanofiller materials together at a temperature of 180° C., a screw rotation speed of 200 rpm, and a mixing time of 2 minutes. In another example, the polymeric and nanofiller materials are mixed in the microextruder at a temperature of 175° C. FIG. 2 is a transmission electron microscopy (TEM) image of an example of the resulting nanocomposites.

The formed nanocomposite material is removed from the microextruder.

Examples of suitable polymeric materials that are used in the preparation of embodiment(s) of the nanocomposite materials include, but are not limited to polypropylenes, a non-limitative example of which is commercially available under the tradename PROFAX 6101 from Basell USA, Inc. located in Lansing, Mich.; propylene copolymers, non-limitative examples of which include commercially available PROFAX 7101 and PROFAX SD 242, both from Basell USA, Inc. located in Lansing, Mich.; and elastomers, a non-limitative example of which is commercially available under the tradename ENGAGE 8150 from Dupont-Dow Elastomers LLC located in Wilmington, Del.

Further non-limitative examples of suitable polymeric materials are shown in Table I under the labels “Polypropylenes,” “Propylene Copolymers” and “Elastomers.” Non-limitative examples of suitable compatibilizing materials are shown in Table I under the label “Compatibilizing Resins.” Non-limitative examples of suitable optional additives are shown in Table I under the label “Antioxidants/Light Stabilizers.”

TABLE 1
Materials

| MATERIAL | SUPPLIER | GRADE |
|---|---|---|
| Polypropylenes | Basell USA, Inc.; | PROFAX 6101, PROFAX 6301, |
| | Lansing, Michigan | PROFAX 6323, PROFAX 6523, |
| | | PROFAX PD 702, PROFAX |
| | | PH020, PROFAX PH 350 |
| | Dow Chemical; Midland, | TF-1802 |
| | Michigan | |
| | Equistar Chemicals LP; | PETROTHENE PP 8001-LK, |
| | Houston, Texas | PETROTHENE PP 8020-AU, |
| | | PETROTHENE PP8020-GU |
| | ExxonMobil Chemical; | PP-1074KN, PP1105E1, PP- |
| | Houston, Texas | 3546G, PP1044 |
| | Huntsman Polymers | H0500NS, P4CCN-41 |
| | LLC; Marysville, | |
| | Michigan | |
| Propylene Copolymers | Basell USA, Inc.; | PROFAX 7101, PROFAX 7601, |
| | Lansing, Michigan | PROFAX EL245S, PROFAX |
| | | SD-242, PROFAX SG-702, |
| | | PROFAX SV-152, HIFAX CA53G |
| | Dow Chemical; Midland, | C700-35N, C702-20, 705-44 NA |
| | Michigan | |
| | Equistar Chemicals LP; | PETROTHENE PP36KK01, |
| | Houston, Texas | PETROTHENE PP35FR03, |
| | | PETROTHENE PP35FU01, |
| | | PETROTHENE PP44FY01, |
| | | PETROTHENE PP44FZ01, |
| | | PETROTHENE PP8752HF, |
| | | PETROTHENE PP8462HR, |
| | | PETROTHENE PP8775HU |
| | ExxonMobil Chemical; | PP-AX03BE5, PP822XE1, |
| | Houston, Texas | MYTEX AN17K-01, |
| | | PP7032KN, PP7033N, PP8023 |
| Elastomers | Basell USA, Inc.; | ADFLEX KS021P, ADFLEX |
| | Lansing, Michigan | KS358P, HIFAX CA207A, |
| | | HIFAX CA10GC, HIFAX |
| | | CA244 |
| | Dupont-Dow Elastomers | ENGAGE 8100, ENGAGE |
| | LLC; Wilmington, | 8150, ENGAGE 8200, |
| | Delaware | ENGAGE 8440, ENGAGE |
| | | 8540, ENGAGE 8842, |
| | | NORDEL IP NDR3722P, |
| | | NORDEL IP NDR4820P, |
| | | NORDEL IP NDR3670, |
| | | NORDEL IP NDR4725P, |
| | | NORDEL IP NDR4770R |
| | Equistar Chemicals LP; | PETROTHENE PP8312-KO, |
| | Houston, Texas | PETROTHENE PP43QW02 |
| | ExxonMobil Chemical; | EXACT 0201, EXACT 0210, |
| | Houston, Texas | EXACT 8201, EXACT 8210, |
| | | EXACT 4053, EXACT 4041, |
| | | EXACT 3035, VISTALON 404, |
| | | VISTALON 707, VISTALON |
| | | 785 |
| Compatibilizing Resins | Eastman Chemical Co.; | EPOLENE E-43, EPOLENE G- |
| | Carpentersville, Illinois | 3003, EPOLENE G-3015, |
| | | EPOLENE C-16, EPOLENE C- |
| | | 18, |
| | Crompton Chemicals; | POLYBOND 1001, |
| | Taft, Louisiana | POLYBOND 1002, |
| | | POLYBOND 1009, |
| | | POLYBOND 3000, |
| | | POLYBOND 3002, |
| | | POLYBOND 3009, |
| | | POLYBOND 3150, |
| | | POLYBOND 3200 |
| | ExxonMobil Chemical; | EXXELOR PO1015, |
| | Houston, Texas | EXXELOR PO1020, |
| | | EXXELOR VA1840 |
| Antioxidants/Light | Ciba Specialty | IRGAFOS 126, IRGAFOS 168, |
| Stabilizers | Chemicals; Tarrytown, | IRGANOX 1010, IRGANOX |
| | New York | 1076, IRGANOX B900, |
| | | IRGASTAB FS 210, |
| | | IRGASTAB FS 301, |
| | | IRGASTAB FS 811, |
| | | IRGASTAB FS 812 |
| | Cytec Industries Inc.; | CYASORB UV531, CYASORB |
| | Kalamazoo, Michigan | UV1164, CYASORB UV3346, |
| | | CYASORB THT4611, |
| | | CYANOX 1212, |
| | | CYANOX 2246 |
| | Great Lakes Polymer | ALKANOX 240, |
| | Additives; West | ALKANOX 240-3T, ANOX 70, |
| | Lafayette, Indiana | LOWINOX CPL |

Referring now to Table 2, the formulas of sets 1, 2, and 3 (TPO Basic Formulas 1, 2, and 3) have various amounts of polymer, copolymer, and elastomer; and the formula of set 4 (PP Basic Formula 1) is a polypropylene formulation. It is to be understood that some of the nanocomposites may include small amounts of a standard clay material (a non-limitative example of which includes a montmorillonite clay that has been modified to be organophilic by an ion exchange with dimethyl, dihydrogenated tallow ammonium chloride).

Some of the formulations do not contain external compatibilizer (formulas A and B). However, for comparison, the various formulations are also tested with the addition of an external compatibilizer (formula C). Commercially available EPOLENE G3015 (a maleated resin) from Eastman Chemical Co. located in Carpentersville, Ill. is a non-limitative example of a compatibilizing material that may be added to the polymeric and nanofiller materials.

An antioxidant, a non-limitative example of which includes IRGASTAB FS 210 (commercially available from Ciba Specialty Chemicals located in Tarrytown, N.Y.), is also added to each of the tested formulations.

Table 2 illustrates the nanocomposite formulas and their corresponding properties. The first column (A) of each set is a control formulation, which includes neither the standard clay nor the external compatibilizer (e.g. maleated resin). The second formulation (B) in each set contains clay, while the third formulation (C) contains both the clay and the external compatibilizer.

TABLE 2
Nanocomposite Formulas & Corresponding Properties
(PPH = Parts Per Hundred)

| FORMULA | A | B | C | A | B | C |
|---|---|---|---|---|---|---|
| | PPH (set 1) | | | PPH (set 2) | | |
| | TPO Basic Formula 1 | | | TPO Basic Formula 2 | | |
| TPO Basic | 100 | 95 | 90 | 100 | 95 | 90 |
| Formula | | | | | | |
| Clay | — | 5 | 5 | — | 5 | 5 |
| Compatibilizer | — | — | 5 | — | | 5 |
| PROPERTIES | | | | | | |
| Flexural | 113 | 172 | 178 | 116 | 158 | 165 |
| Modulus | | | | | | |
| (kpsi) | | | | | | |
| Flexural | 790.2 | 1202.8 | 1244.8 | 811.2 | 1104.9 | 1153.8 |
| Modulus | | | | | | |
| (Mpa) | | | | | | |
| Shrink (mm/m) | 14.3 | 12.6 | 12.6 | 14.7 | 13.2 | 12.7 |
| Coefficient of | 13.4 | 10.4 | 10.6 | 13.3 | 10.9 | 11.1 |
| Linear Thermal | | | | | | |
| Expansion | | | | | | |
| (CLTE) | | | | | | |
| (mm/mm/C) | | | | | | |
| Mean Free Path | — | 1.2 | 1.3 | — | 2.5 | 0.61 |
| (MFP) | | | | | | |
| X-ray | No peak | 26.8 | 30.6 | No peak | 28.3 | 30.6 |
| % crystallinity | — | 33% | 35% | — | 30% | 30% |
| | PPH (set 3) | | | PPH (set 4) | | |
| | TPO Basic Formula 3 | | | PP Basic Formula | | |
| Basic Formula | 100 | 95 | 90 | 100 | 95 | 90 |
| Clay | — | 5 | 5 | — | 5 | 5 |
| Compatibilizer | — | — | 5 | — | — | 5 |
| PROPERTIES | | | | | | |
| Flexural | 199 | 291 | 288 | 161 | 233 | 214 |
| Modulus | | | | | | |
| (kpsi) | | | | | | |
| Flexural | 1391.6 | 2035 | 2014 | 1125.9 | 1629.4 | 1496.5 |
| Modulus | | | | | | |
| (MPa) | | | | | | |
| Shrink (mm/m) | 14.6 | 17.1 | 16.1 | 18.9 | 15.5 | 16.2 |
| CLTE | 11.6 | 9.68 | 9.36 | 12.7 | 10.3 | 10.6 |
| (mm/mm/C) | | | | | | |
| MFP | — | 1.8 | 0.73 | — | 0.98 | 0.79 |
| X-ray | No peak | 27.7% | 31.3% | No peak | 29% | 31.3% |

In set 1, the flexural moduli, with external compatibilizer (C) and without external compatibilizer (B), are 178 and 172 Kpsi, respectively. Set 2 yields flexural moduli of 165 and 158 Kpsi, with external compatibilizer (C) and without external compatibilizer (B), respectively. Set 3 has flex moduli, with external compatibilizer (C) and without external compatibilizer (B), of 288 and 291 Kpsi respectively; while set 4 (PP Basic Formula 1) has 214 and 233 Kpsi, with external compatibilizer (C) and without external compatibilizer (B), respectively. It is to be understood that any differences between the formulations (B and C for each set) are less than the experimental error. These results demonstrate that when using embodiments of the present method employing the conical twin-screw extruder, desirable, substantially high flexural moduli may be achieved without addition of external compatibilizer.

In prior studies, it has generally been found that formulations including clay (without an external compatibilizer) may, as a result of higher crystallinity, increase the flexural modulus. In this example, the X-ray diffraction is measured for the formulations including clay (B) and for those including both clay and compatibilizer (C) of sets 1 and 2. The percent crystallinity is calculated from the X-ray diffraction values. As shown above in Table 2, the crystallinity values of formulations with clay are very close (or substantially identical) to those containing both clay and compatibilizer. This demonstrates that the extent of crystallinity may have little or substantially no influence on the flexural modulus of the formulations including and not including the external compatibilizer.

It is to be understood that the nanocomposite material(s) according to embodiments of the present method may be suitable for many applications. One non-limitative example of such an application includes use as an automotive interior body material and/or an automotive exterior body material.

Embodiments of the present method offer many advantages, some of which are as follows. An embodiment using the co-rotating conical twin-screw extruder geometry may induce the material(s) to follow a geometrically substantially regular path (a non-limitative example of which is a figure eight path) as it proceeds through the extruder. This substantially regular path may advantageously impart more distributive mixing, and may also impart less sheer upon the material(s). Without being bound to any theory, it is believed that less shear and more distributive mixing may result in reduced frictional effects (and thus less heat) of the conical screws. It is further believed that the mixing and shearing motions of the co-rotating conical twin-screw extruder advantageously allow the polymeric material and nanofiller material to form a nanocomposite material having enhanced properties, without the addition of an external compatibilizer. Traditionally, an external compatibilizer had been utilized in order to overcome the barriers associated with the incompatibility of the inorganic phase with the organic matrix.

While several embodiments have been described in detail, it will be apparent to those skilled in the art that the disclosed embodiments may be modified. Therefore, the foregoing description is to be considered exemplary rather than limiting.

1. A method for making a nanocomposite material, the method comprising the steps of:
introducing a polymeric material into a conical twin-screw extruder; and
introducing a nanofiller material into the polymeric material within the conical twin-screw extruder, the extruder being adapted to impart substantially gentle shearing of the polymeric material and the nanofiller material, thereby forming the nanocomposite material;
wherein the nanofiller material is dispersible within the polymeric material without an external compatibilizing material;
and wherein the nanocomposite material exhibits at least one of enhanced physical properties and enhanced mechanical properties.

2. The method as defined in claim 1 wherein the nanofiller material comprises a clay material including at least one of smectite, hectorite, montmorillonite, bentonite, beidelite, saponite, stevensite, sauconite, nontronite, illite, and mixtures thereof.

3. The method as defined in claim 1 wherein the conical twin-screw extruder is adapted to impart substantially elongational shear of the polymeric material and the nanofiller material.

4. The method as defined in claim 1 wherein the conical twin-screw extruder comprises a re-circulating channel.

5. The method as defined in claim 1 wherein the polymeric material comprises thermoplastic materials.

6. The method as defined in claim 5 wherein the thermoplastic materials comprise thermoplastic olefins including at least one of polypropylenes, polypropylene homopolymers, impact modified polypropylenes, ethylene-propylene elastomers, polyethylenes, elastomers, impact copolymers thereof, and mixtures thereof.

7. The method as defined in claim 5 wherein the thermoplastic materials comprise at least one of polypropylenes, polyethylenes, elastomers, polyolefins, impact copolymers thereof, polyamides, polystyrene, polyethyleneterephthalate, polymethylmethacrylate, polycarbonate, polyurethane, poly(acrylonitrile-co-butadiene-co-styrene) (ABS), poly(acrylonitrile-co-styrene-co-acrylate) (ASA), poly(styrene-co-butadiene-co-styrene) (SBS), polycarbonate-poly(acrylonitrile-co-butadiene-co-styrene) (PC-ABS), and mixtures thereof.

8. The method as defined in claim 1 wherein the polymeric material and nanofiller material are introduced substantially simultaneously into the extruder.

9. The method as defined in claim 1 wherein the polymeric material and nanofiller material are introduced sequentially into the extruder.

10. The method as defined in claim 1, further comprising mixing the polymeric material and the nanofiller material in the extruder for a predetermined amount of time.

11. The method as defined in claim 1 wherein the nanocomposite material is adapted for use in at least one of automotive interior panels and automotive exterior panels.

12. The method as defined in claim 1 wherein the conical twin-screw extruder comprises two co-rotating screws.

13. The method as defined in claim 1 wherein the conical twin-screw extruder has a shear rate value ranging between about 70 s⁻¹ and about 500 s^{-1.}

14. A method for making a nanocomposite material, the method comprising the steps of:
introducing a polymeric material into a co-rotating conical twin screw extruder; and
introducing a nanofiller material into the polymeric material within the co-rotating conical twin-screw extruder, the extruder being adapted to move the polymeric material and the nanofiller material in a geometrically substantially regular path through the extruder and to impart substantially gentle shearing of the polymeric material and the nanofiller material, thereby forming the nanocomposite material;
wherein the nanofiller material is dispersible within the polymeric material without an external compatibilizing material;
and wherein the nanocomposite material exhibits at least one of enhanced physical properties and enhanced mechanical properties.

15. The method as defined in claim 14 wherein the nanofiller material comprises a clay material including at least one of smectite, hectorite, montmorillonite, bentonite, beidelite, saponite, stevensite, sauconite, nontronite, illite, and mixtures thereof.

16. The method as defined in claim 14 wherein the co-rotating conical twin-screw extruder imparts substantially elongational shear of the polymeric material and the nanofiller material.

17. The method as defined in claim 14 wherein the conical twin-screw extruder comprises a re-circulating channel.

18. The method as defined in claim 14 wherein the polymeric material comprises thermoplastic materials.

19. The method as defined in claim 18 wherein the thermoplastic materials comprise thermoplastic olefins including at least one of polypropylenes, polypropylene homopolymers, impact modified polypropylenes, ethylene-propylene elastomers, polyethylenes, elastomers, impact copolymers thereof, and mixtures thereof.

20. The method as defined in claim 18 wherein the thermoplastic materials comprise at least one of polypropylenes, polyethylenes, elastomers, polyolefins, impact copolymers thereof, polyamides, polystyrene, polyethyleneterephthalate, polymethylmethacrylate, polycarbonate, polyurethane, poly(acrylonitrile-co-butadiene-co-styrene) (ABS), poly(acrylonitrile-co-styrene-co-acrylate) (ASA), poly(styrene-co-butadiene-co-styrene) (SBS), polycarbonate-poly(acrylonitrile-co-butadiene-co-styrene) (PC-ABS), and mixtures thereof.

21. The method as defined in claim 14 wherein the polymeric material and nanofiller material are introduced substantially simultaneously into the extruder.

22. The method as defined in claim 14 wherein the polymeric material and nanofiller material are introduced sequentially into the extruder.

23. The method as defined in claim 14, further comprising mixing the polymeric material and the nanofiller material in the extruder for a predetermined amount of time.

24. The method as defined in claim 14 wherein the nanocomposite material is adapted for use in at least one of automotive interior panels and automotive exterior panels.
